(19) United States
(12) Patent Application Publication
(10) Pub. No.: US 2002/0041797 A1
(43) Pub. Date: Apr. 11, 2002

(54) Drill gauge

(75) Inventor: Luciano Salice, Carimate (IT)

Correspondence Address: Rocco S. Barrese, Esq., DILWORTH & BARRESE, LLP, 333 Earle Ovington Blvd., Uniondale, NY, 11553, US

(73) Assignee: Arturo Salice S.P.A.

(21) Appl. No.: 09/970,759

(22) Filed: Oct. 4, 2001

(30) Foreign Application Priority Data
Oct. 5, 2000 (DE) 200 17 146.1

(51) Int. Cl. B23B 49/00; B23B 51/02

(52) U.S. Cl. 408/14; 408/97; 408/103; 408/115 R; 408/226; 408/202

(57) ABSTRACT

A drill gauge for the drilling of blind boreholes of a pre-determined depth in board-shaped parts, preferably into furniture parts, has end faces forming reference edges. An abutment body, which can be applied to the end faces and which is provided with devices for fastening to the board-shaped parts, is provided so as to be able to apply blind boreholes of a pre-determined depth at pre-determined points of board-shaped parts. The abutment body has a borehole flush with the blind borehole to be drilled for the insertion of the drill at whose outer rim an abutment part applied to the shaft of the drill is supported which determines the penetration depth of the drill.

The invention relates to a drill gauge for the drilling of blind boreholes of a pre-determined depth into board-shaped parts, preferably into furniture parts, having end faces forming reference edges.

Board-shaped parts, and in particular furniture parts, frequently have to be provided with fitting parts such as hinges or stop and brake devices. Such fitting parts are usually screwed to parts consisting of wood and/or plastic or chipboards. Drill gauges for the pre-drilling of the fastening bores are usually used so as not to have to mark the fastening bores beforehand in a complicated manner. A particular problem arises in addition when blind boreholes of a pre-determined depth have to be drilled. Such blind boreholes of a pre-determined depth must, for example, be drilled into furniture parts when these serve the holding of brake apparatuses of the kind laid down in DE 299 10 626 U1.

It is therefore the object of the invention to provide a drill gauge of the kind initially given with which blind boreholes of a pre-determined depth can be applied at pre-determined points of board-shaped parts.

This objects is solved in accordance with the invention with a drill gauge of the kind initially given by an abutment body which can be applied to the end faces of the board-shaped parts, which is provided with devices for the fastening to the parts and which has a borehole flush with the blind borehole to be drilled for the insertion of a drill on whose outer edge an abutment part fitted to the shaft of the drill is supported, said abutment part determining the penetration depth of the drill.

The drill gauge of the invention can, on the one hand, be fastened in a correctly positioned manner to the board-shaped part such that the blind bore can be drilled at the pre-determined point. On the other hand, the drill gauge of the invention ensures that the blind borehole is executed in the pre-determined depth.

The abutment body is appropriately provided with a stub-like collar which is penetrated by the borehole and whose rim forms an abutment for the abutment part. The abutment part itself can consist of a pin held in a transverse bore of the shaft of the drill. In accordance with another embodiment, the drill could also be provided with an annular flange limiting the penetration depth.

The penetration depth of the drill can additionally also be varied by one or more rings which can be pushed onto the drill.

In accordance with a preferred embodiment, which allows the application of blind boreholes to the narrow end faces of board-shaped parts, it is provided that the abutment body has sides adjoining its contact surface at right angles which are provided with gripping jaws which project over it, one of said gripping jaws being movable by screws or spindles. The drill gauge can be clamped in the correct position to the board-shaped part to be provided with a borehole by a gripping jaw movable by means of screws or spindles in the manner of a screw clamp.

The one gripping jaw appropriately consists of a board provided with two tapped boreholes, with threaded bolts with actuating buttons being screwed into the two tapped boreholes whose shafts are held rotatably, but in an immobile manner in the axial direction, in the abutment body.

In accordance with another embodiment, the gripping jaw can also have two boreholes which are penetrated by threaded bolts screwed into the abutment body.

The other gripping jaw can be screwed to the abutment body. In another aspect of the invention, it is provided that the other gripping jaw has a shoulder roughly flush with the contact surface of the abutment body in order to centre or modify the distance of the blind borehole to be applied to an edge of the end face.

Embodiments of the invention are explained in more detail in the following with reference to the drawing, in which are shown:

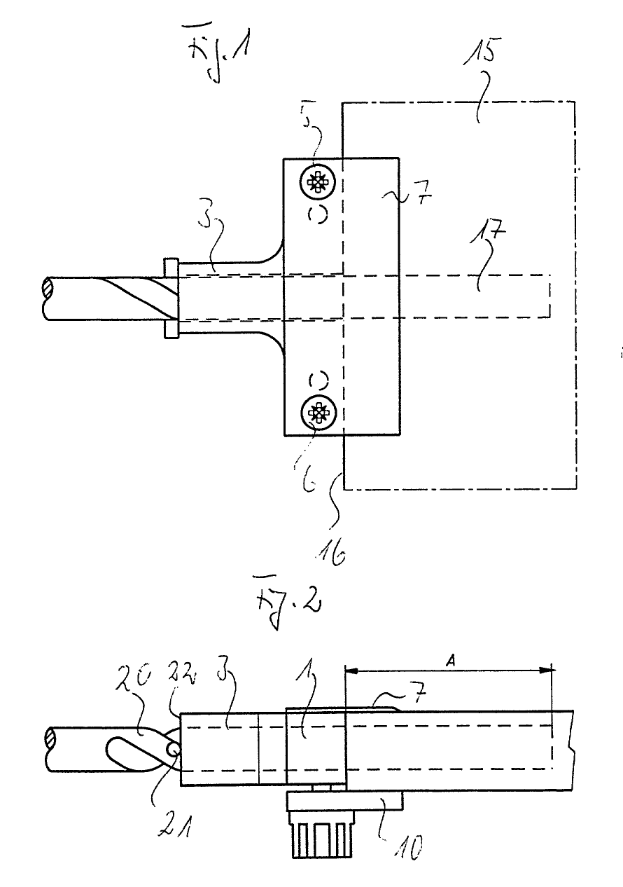

FIG. 1 a plan view of a drill gauge clamped to the rim of an end face of a board-shaped part;

FIG. 2 a side view of the drill gauge of FIG. 1 clamped to a board;

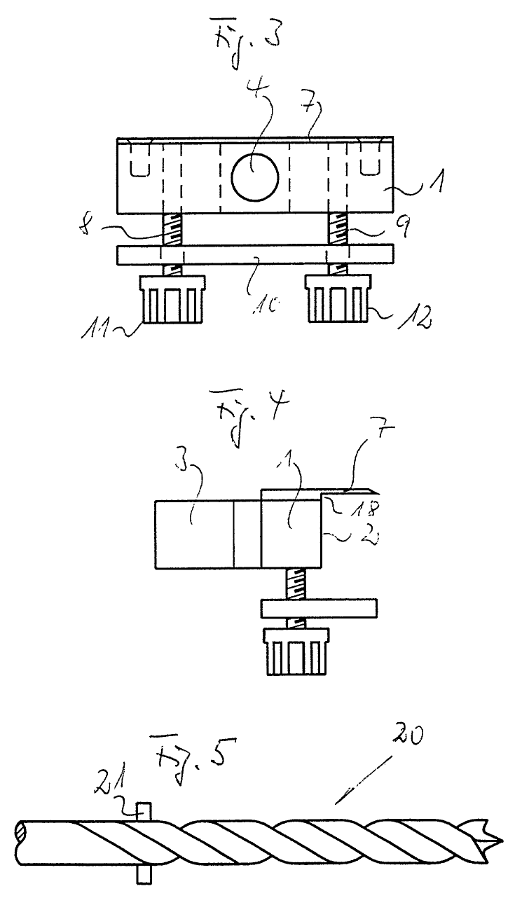

FIG. 3 a view of the drill gauge of FIGS. 1 and 2 in the direction of its contact surface;

FIG. 4 a side view of the drill gauge of FIG. 3 in which the upper gripping jaw is provided with a shoulder; and

FIG. 5 a drill provided with an abutment pin.

The drill gauge shown in the drawing consists of a roughly cuboid abutment body 1 of metal or plastic, which is provided on its side opposite the contact surface 2 with a stub-shaped collar 3 which is provided with a borehole which extends the borehole 4 of the abutment body 1. The abutment body 1 provided with the stub-shaped collar 3 is formed symmetrically to its transverse middle plane which coincides with a diameter plane of the bore 4.

A gripping jaw 7, which consists of a rectangular board and which projects over the contact surface 2 of the abutment body 1, is screwed to the upper side of the abutment body 1 by two fastening screws 5, 6.

The abutment body 1 is provided on its side opposite the gripping jaw 7 with tapped boreholes in which threaded bolts 8, 9 are screwed. Actuating buttons 11, 12 are set onto extreme ends of the threaded bolts 8, 9 which penetrate the through boreholes of a gripping jaw 10 which also consists of a rectangular board. By simultaneously turning the two buttons 11, 12, the gripping jaw 10 can approach the gripping jaw 7 in the manner of a screw clamp such that the drill gauge can be clamped to a board-shaped part 15 in the manner visible from FIGS. 1 and 2. If the board-shaped part 15 should be provided with a blind borehole 17 of a pre-determined depth A in its end face 16, the contact surface 2 of the drill gauge is set at the end face 16 such that the borehole 4 is at that point at which the blind borehole 17 is to be made. In this position, the buttons 11, 12 are then turned for the clamping of the gripping jaws 7, 10 to the board-shaped part 15.

In the embodiment of the drill gauge of FIG. 4, the upper gripping jaw 7 is provided with a shoulder 18 which is in the plane of the contact surface 2 of the abutment body 1. The height of the shoulder 18 can be changed for the centration or alignment of the blind borehole 17 to be applied in the end face 16 of the board-shaped part.

The diameter of the borehole 4 is matched to the diameter of the drill 20. The drill 20 is provided with a transverse borehole in its shaft in which a pin 21 is held which is supported on the rim 22 of the stub-like collar 3 to determine the depth of the blind borehole 17. The point at which the pint 21 is disposed on the shaft of the drill 20 determines the depth A of the blind borehole 17 due to the geometry of the drill gauge.

1. A drill gauge for the drilling of blind boreholes (17) of a pre-determined depth into board-shaped parts, preferably into furniture parts (15), having end faces (16) forming reference edges, characterized by an abutment body (1) which can be applied to the end faces (16), which is provided with devices for fastening to the board-shaped parts and which has a borehole (4) flush with the blind borehole (17) to be drilled for the insertion of a drill (20), at whose outer rim (22) an abutment part (21) applied to the shaft of the drill (20) is provided which determines the penetration depth of the drill (20).

2. A drill gauge in accordance with claim 1, wherein the abutment body (1) is provided with a stub-like collar (3) which is penetrated by the borehole (4) and whose rim (22) forms an abutment for the abutment part (21).

3. A drill gauge in accordance with either of claims 1 or 2, wherein the abutment part consists of a pin (21) held in a transverse bore of the shaft of the drill (20).

4. A drill gauge in accordance with any of claims 1 to 3, wherein one or more rings are provided which can be pushed onto the drill (20).

5. A drill gauge in accordance with any of claims 1 to 4, wherein the abutment body (1) has sides which adjoin its contact surface (2) at right angles and which are provided with gripping jaws (7, 10) which project over this, one (10) of said gripping jaws being movable by screws (8, 9) or spindles.

6. A drill gauge in accordance with claim 5, wherein the one gripping jaw consists of a board (10) provided with two tapped boreholes and wherein threaded bolts (8, 9) having actuating buttons (11, 12) are screwed into the tapped bores, the shafts of said threaded bolts being rotatable in the abutment body (1), but held immovably in the axial direction.

7. A drill gauge in accordance with claim 5, wherein the screws (8, 9) are screwed rotatably in the abutment body (1) and penetrate through boreholes of the gripping jaw (10).

8. A drill gauge in accordance with any of claims 1 to 7, wherein the other gripping jaw (7) is screwed to the abutment body (1).

9. A drill gauge in accordance with any of claims 1 to 8, wherein the other gripping jaw (7) has a shoulder (18) roughly flush to the contact surface (2) of the abutment body (1).
